(19) United States
(12) Patent Application Publication
(10) Pub. No.: US 2025/0384088 A1
(43) Pub. Date: Dec. 18, 2025

(54) DATA RECOMMENDATION

(71) Applicants: Lemon Inc., Grand Cayman (KY); Beijing Zitiao Network Technology Co., Ltd., Beijing (CN)

(72) Inventors: Yu Zhang, Los Angeles, CA (US); Anshu Wang, Los Angeles, CA (US); Kan Wang, Beijing (CN); Zhenze Du, Singapore (SG); Shen Wang, Los Angeles, CA (US); Yue YU, Los Angeles, CA (US)

(21) Appl. No.: 19/045,717

(22) Filed: Feb. 5, 2025

(30) Foreign Application Priority Data
Jun. 17, 2024 (CN) 202410781307.3

(51) Int. Cl. G06F 16/903

(52) U.S. Cl. CPC G06F 16/903

(57) ABSTRACT

A method, an apparatus, a device and a medium for recommending data are provided. In a method, first feature data of an object is obtained. A permission type for using the first feature data is obtained, the permission type specifying a portion of the first feature data allowed to be used in data recommendation. The first feature data is updated based on the permission type to generate second feature data; and based on the second feature data, a group of data items matching the second feature data is determined from a data set including a plurality of data items.

### CROSS-REFERENCE

This application claims the benefit of Chinese Patent Application No. 202410781307.3 filed on Jun. 17, 2024, entitled “METHOD, APPARATUS, DEVICE, AND MEDIUM FOR RECOMMENDING DATA”, which is hereby incorporated by reference in its entirety.

### FIELD

Example implementations of the present disclosure relate generally to data recommendation, and more particularly, to a data recommendation from a data set.

### BACKGROUND

Machine learning techniques have been widely used in a variety of application areas, for example, data may be recommended using a machine learning model. Currently, a technical solution of training a machine learning model based on a plurality of features of an object has been proposed, and data can further be recommended by using the trained machine learning model. However, comprehensive feature data may not be available for certain reasons and/or the provider is reluctant to provide certain feature data, resulting in unsatisfactory efficiency and accuracy of machine learning models in recommending data. At this point, it is desirable to recommend data in a more flexible and efficient manner.

### SUMMARY

In a first aspect of the present disclosure, a method for recommending data is provided. The method includes: obtaining first feature data of an object; obtaining a permission type for using the first feature data, the permission type specifying a portion of the first feature data allowed to be used in data recommendation; updating the first feature data based on the permission type to generate second feature data; and determining, from a data set including a plurality of data items, a group of data items matching the second feature data based on the second feature data.

In a second aspect of the present disclosure, an apparatus for recommending data is provided. The apparatus includes: a data obtaining module configured to obtain first feature data of an object; a permission obtaining module configured to obtain a permission type for using the first feature data, the permission type specifying a portion of the first feature data allowed to be used in data recommendation; a generating module configured to update the first feature data based on the permission type to generate second feature data; and a determining module configured to determine, from a data set including a plurality of data items, a group of data items matching the second feature data based on the second feature data.

In a third aspect of the present disclosure, an electronic device is provided. The electronic device includes: at least one processor; and at least one memory coupled to the at least one processor and storing instructions for execution by the at least one processor that, when executed by the at least one processor, cause the electronic device to perform the method according to the first aspect of the present disclosure.

In a fourth aspect of the present disclosure, a computer readable storage medium is provided, the computer readable storage medium having stored thereon a computer program which, when executed by a processor, causes the processor to implement the method according to the first aspect of the present disclosure.

In a fifth aspect of the present disclosure, there is provided a computer program product, including a computer program, where the computer program, when executed by a processor, implements the method according to the first aspect of the present disclosure.

It should be appreciated that what is described in this Summary is not intended to limit the key features or essential features of the implementations of the present disclosure, nor is it intended to limit the scope of the present disclosure. Other features of the present disclosure will become readily appreciated from the following description.

### BRIEF DESCRIPTION OF THE DRAWINGS

Hereinafter, the above and other features, advantages, and aspects of various implementations of the present disclosure will become more apparent with reference to the following detailed description taken in conjunction with the accompanying drawings. In the drawings, identical or similar reference signs denote identical or similar elements, where:

FIG. 1 illustrates a block diagram of a data recommendation environment according to some example implementations of the present disclosure;

FIG. 2 illustrates a block diagram for recommending data according to some implementations of the present disclosure;

FIG. 3 illustrates a block diagram of a plurality of portions of feature data according to some implementations of the present disclosure;

FIG. 4 illustrates a block diagram of a data recommendation process according to some implementations of the present disclosure;

FIG. 5 illustrates a flowchart of a method for recommending data according to some implementations of the present disclosure;

FIG. 6 illustrates a block diagram of an apparatus for recommending data according to some implementations of the present disclosure; and

FIG. 7 illustrates a block diagram of a device capable of implementing various implementations of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of protection of the present disclosure.

In the description of implementations of the present disclosure, t the term “including” and the like should be understood as open-ended including, that is, “including but not limited to”. The term “based on” should be understood as “based at least in part on”. The term “one implementation” or “the implementation” should be understood as “at least one implementation”. The term “some implementations” should be understood as “at least some implementations”. Other explicit and implicit definitions may also be included below. As used herein, the term “model” may denote an association relationship between respective data. The association relationship may be obtained, for example, based on a variety of technical solutions that are currently known and/or will be developed in the future.

It will be appreciated that the data involved in the present technical solution (including but not limited to the data itself, the acquisition or use of the data) should comply with the requirements of the corresponding legal regulations and related provisions.

It should be understood that, before the technical solutions disclosed in the embodiments of the present disclosure are used, the user should be informed of the type of the personal information, the usage range, the usage scenario, and the like related to the present disclosure and the authorization of the user should be obtained in an appropriate manner according to relevant legal regulations.

For example, in response to receiving an active request from a user, prompt information is sent to the user to explicitly prompt the user that an operation requested to be executed by the user needs to obtain and use personal information of the user, so that the user can autonomously select, according to the prompt information, whether to provide the personal information to software or hardware such as an electronic device, an application program, a server, or a storage medium that executes the operation of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the popup window may also carry a selection control for the user to select whether he/she “agrees” or “disagrees” to provide personal information to the electronic device.

It should be understood that, the above notification process and the process of obtaining the user's authorization are merely exemplary, which do not limit the implementation of the present disclosure, and other methods meeting relevant legal regulations may also be applied to the implementation of the present disclosure.

As used herein, the term “in response to” refers to a state in which a corresponding event occurs or a condition is satisfied. It will be appreciated that the timing for performing a subsequent action that is performed in response to the event or condition, and the time when the event occurs or the condition is satisfied, are not necessarily strongly correlated. For example, in some cases, subsequent actions may be performed immediately upon occurrence of an event or upon satisfaction of a condition; In other cases, subsequent actions may be performed only after a period of time has passed after an event occurs or a condition is established.

### Example Environment

Machine learning techniques have been widely used in a variety of application areas, for example, data may be recommended using a machine learning model. At present, a technical solution of training a machine learning model based on a plurality of features of an object has been proposed, and then a data recommendation task is performed by using the trained machine learning model.

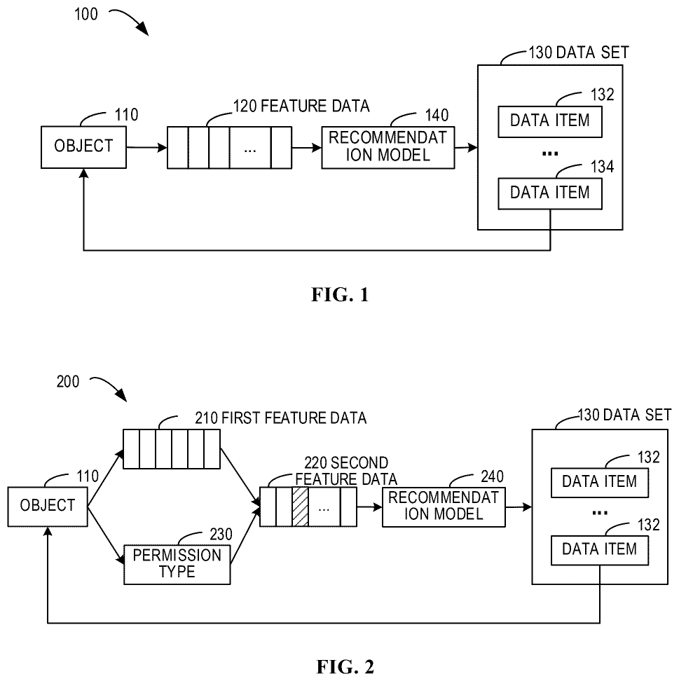

An application environment according to some example implementations of the present disclosure is described with reference to FIG. 1. FIG. 1 illustrates a block diagram 100 of a data recommendation environment according to some example implementations of the present disclosure. As illustrated in FIG. 1, feature data 120 of an object 110 may be extracted based on information of the object 110 at a plurality of aspects. For convenience of description, the technical solutions of the present disclosure will hereinafter be described only by taking a user as an example of the object 110. For example, the object 110 may be a user in a data recommendation environment, and the object 110 may access various data items in a data set 130. Alternatively and/or additionally, the object 110 may further include, for example, a company, or other organization, etc.

The data set 130 may include a large number of data items 132, . . . , 134, and there may be a massive amount of data. In this case, it is desired to recommend to an object 110 a data item that the object 110 may be interested in. The feature data 120 may be generated based on information of multiple aspects of the object 110, which may be input to the recommendation model 140 (e. g., a machine learning model that has been trained). At this point, the recommendation model 140 may find from the data set 130 one or more data items (e. g., the data item 134, etc.) that match the feature data 120 and provide the found one or more data items to the object 110.

However, comprehensive feature data cannot be obtained for some reasons and/or the user is reluctant to use certain parts of the feature data, which results in unsatisfactory efficiency and accuracy of the machine learning model in data recommendation. For example, a user may not wish to provide its first type data for reasons such as protecting security data. This results in the recommendation model 140 not being able to obtain information about the object 110 based on the complete feature data 120, and thus not being able to find data from the data set 130 that the object interests. In this case, it is desirable to recommend data in a more flexible and efficient manner, and in particular, it is desirable to improve performance of a data recommendation task without using all feature data.

### Summary of Data Recommendation

To at least partially address the deficiencies in the prior art, according to some example implementations of the present disclosure, a method for recommending data is presented. An overview of some example implementations according to the present disclosure is described with reference to FIG. 2, which illustrates a block diagram 200 for recommending data in accordance with some implementations of the present disclosure. As shown in FIG. 2, first feature data 210 of the object 110 may be obtained. Specifically, the first feature data 210 may be obtained while data security is ensured. It should be appreciated that in the context of the present disclosure, the mentioned feature data is represented in a multi-dimensional vector format and is invisible to the outside and does not expose the security information.

Further, a permission type 230 for using the first feature data 210 may be obtained. Here, the permission type 230 may specify a portion of the first feature data 210 that is allowed to be used in the data recommendation. For example, the permission type 230 may specify that all of the first feature data 210 are allowed to be used to perform a data recommendation task; alternatively, and/or additionally, the permission type 230 may specify that only a portion of the first feature data 210 is allowed to be used to perform a data recommendation task. The first feature data 210 may be updated based on the permission type 230 to generate the second feature data 220. For example, a portion that is not allowed to be used may be removed from the first feature data 210 to generate the second feature data 220. Further, the second feature data 220 may be input into the recommendation model 240 to determine, based on the second feature data 220, a group of data items matching the second feature data from the data set 130 including the plurality of data items.

With exemplary implementations of the present disclosure, permission types can be utilized to indicate portions of the feature data that are allowed to be used and/or portions that are not allowed to be used. For example, features that are not expected for use and/or features that may cause potential data risks may be excluded from the data recommendation process. In this way, the data security of the data recommendation process may be improved, and the data recommendation performance is improved on the basis of ensuring the data security.

### Detailed Process of Data Recommendation

Having described an overview of some example implementations according to the present disclosure, in the following, more details of some example implementations according to the present disclosure are described with reference to the accompanying drawings. According to some example implementations of the present disclosure, the first feature data may include a plurality of feature dimensions of an object. For example, for a user, the plurality of feature dimensions may include, for example, without limitation, a user identification, a region, an interest, a type of client, etc. For data security considerations, some users do not wish to use their own first data type (e. g., region, etc.).

According to some example implementations of the present disclosure, a user is allowed to specify a permission type 210, and the permission type 210 indicates at least a portion of feature dimensions in the plurality of feature dimensions. For example, a user may specify that only feature dimensions, such as interests, types of clients, are to be used, and feature dimensions, such as region, are not to be used. At this point, in a process of generating the second feature data, the second feature data 220 may be generated based on at least a portion of the feature dimensions specified by the permission type 210. With example implementations of the present disclosure, more flexibility and higher security may be provided to users during data recommendation, thereby reducing the risk of leaking the first data type.

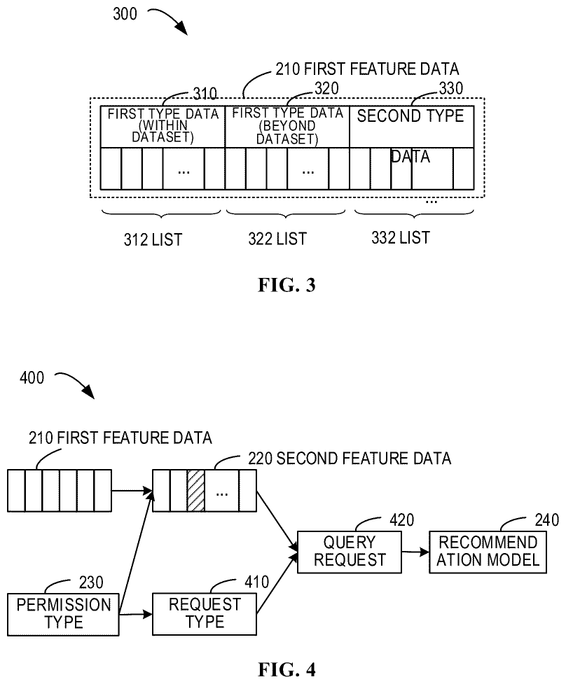

More information regarding the feature data is described with reference to FIG. 3, which illustrates a block diagram 300 of portions of the feature data according to some implementations of the present disclosure. As shown in FIG. 3, first feature data 210 may include a plurality of portions: first type data 310, first type data 320, and second type data 330. At this point, at least a portion of the feature dimension can be specified with the permission type 210. Here, at least a portion of the feature dimension may include a first type data associated with the object, and/or a second type data associated with the object. Further, the first type data includes a first type data within the data set (i. e., the first type data 310) and a first type data beyond the data set (i. e., the first type data 320).

It should be appreciated that the first type data 310 herein may include, for example, a first type data of the user within the data set, e. g., region, interests, and data of various events related to the user (e. g., review data, subscription data, and further operations for the data, etc.), among others. The first type data 320 may include a first type data of the user beyond the data set. e. g., the user may comment on, subscribe to, etc., data in other data sets. For ease of distinction, the data set 130 may be referred to as a first data set, and related data beyond the first data set may be referred to as a second data set.

In this case, the first type data in the second data set may be associated to the current data set, for example, by a telephone number, a mail address, or the like of the user, and thus such first type data 320 may be referred to as the first type data in the second data set. The first type data 310 and 320 may relate to security information, and thus the user may exclude the use of the first type data by setting a permission type. Further, the second type of data 330 represents portions of the feature data other than the first type data, such data not involving security information.

According to some example implementations of the present disclosure, a respective list may be provided for respective portions of data. For example, a list 312 may be utilized to specify various dimension features in the first type data 310, a list 322 may be utilized to specify various dimension features in the first type data 320, and a list 332 may be utilized to specify various dimension features in the first type data 330. In this way, the dimension features that are allowed to be used can be adjusted in a more flexible manner. Without modifying the specific logic of the data recommendation process, the feature dimensions that are allowed to be used can be adjusted by modifying each list directly. In this way, the performance of the data recommendation process may be further improved.

For convenience of description, all personalization data may be referred to as P data (including first type data 310 (referred to as first-party data, First Party, abbreviated FP or IP) and first type data 320 (referred to as third-party data, abbreviated 3P)), and the second type data 330 may be referred to as non-personalized data (Non-Personalized, abbreviated NP). According to some example implementations of the present disclosure, the permission type may specify that P data, FP data, or NP data are allowed to be used. In particular, the permission type can be represented using different numbers, e. g., Permission Type=1 indicates that the P data is allowed to be used during data recommendation, Permission Type=0 indicates that NP data is allowed to be used during data recommendation, and Permission Type=2 indicates that FP data is allowed to be used during data recommendation. Alternatively, and/or additionally, other numbers may be used to represent different types of data, respectively. For another example, Permission type=3 may be defined to indicate that 3P data is allowed to be used, etc.

According to some example implementations of the present disclosure, a first number of dimensions of the first feature data is the same as a second number of dimensions of the second feature data. In this manner, the proposed data recommendation solution can be made compatible with existing recommendation models without modifying the structure (e. g., feature width) of the recommendation models. Further, portions that are not allowed to be used may be removed from the first feature data to generate the second feature data. For example, portions that are not allowed to be used may be removed using a mask operation, in other words, other feature dimensions than the at least a portion of the feature dimensions in the second feature data are set to be null.

It is assumed that the permission type indicates that of NP data is allowed to be used, the first type data 310 and 320 in FIG. 3 may be removed (setting the various feature dimensions of the data described above to null). Given that the permission type indicates that the FP data is allowed to be used, the various feature dimensions in the first type data 320 in FIG. 3 may be set to null.

According to some example implementations of the present disclosure, the range of the first type data may be different for different regions. In this case, in order to determine which feature data is specified by the as being allowed to be used, region information corresponding to the object may be determined, and at least a part of feature dimensions is determined based on the region information. Using example implementations of the present disclosure, the feature dimensions allowed to be used may be determined according to a data security specification that more closely matches the region where the object is currently located. For example, assuming that the user specifies that the P data is allowed to be used, in response to determining that the user is located in region A, it may be determined that the P data includes both the IP data and the 3P data; in response to determining that the user is located in region B, the P data may be determined to include only the IP data, and so on.

According to some example implementations of the present disclosure, in order to determine a group of data items, a request type of a query request for querying a data set may be determined based on a permission type, and then a group of data items matching the request type may be obtained from the plurality of data items. Here, the request type may be expressed in the same manner as the permission type. Continuing with the above example, request type=1 indicates that the request is allowed to use the P data, request type=1 indicates that the request is allowed to use the NP data, and request type=2 indicates that the request is allowed to use the FP data.

Assuming that the specific query request allows the use of the P data, the recommendation data found by using the P data may be returned from the data set; assuming that the specific query request allows the use of the NP data, the recommendation data found by using the NP data may be returned from the data set. By means of the example implementation of the present disclosure, a field representing a request type can be added to feature data, thereby simplifying a data recommendation process based on a specific numerical value of the field.

According to some example implementations of the present disclosure, individual data items in a data set may have respective data types. Here, the data type may indicate an association between a data item and a query type. At this point, it may be determined whether a certain data item may be returned by comparing the request type with a data type of each data item. In particular, to obtain a group of data items, in response to determining that the association relationship indicates that the data type of the data item matches the query type, the data item is added to the group of data items. Specifically, for NP-type requests, only NP-type data items are returned; for P-type requests, both NP-type data items and P-type data items are returned. More details are described with respect to Table 1, which shows an example of returning data items based on association relationships.

TABLE 1
Example of returning data items based on association relationships

| Serial | Permission | Request | Data | Association |
|---|---|---|---|---|
| No. | type | type | type | relationship |
| 1 | 1(P) | 1(P) | NP: Request type = [0, 2] | Matched |
| | | | P: Request type = 1 | Matched |
| | | | FP: Request type = 2 | Matched |
| 2 | 0(NP) | 0(NP) | NP: Request type = [0, 2] | Matched |
| | | | P: Request type = 1 | Not matched |
| | | | FP: Request type = 2 | Not matched |
| 3 | 2(FP) | 2(FP) | NP: Request type = [0, 2] | Matched |
| | | | P: Request type = 1 | Not matched |
| | | | FP: Request type = 2 | Matched |

As shown in Table 1, the permission type may include a P type, a NP type, and a FP type, and similarly, the request type may include a P type, a NP type, and a FP type. Further, the data type can also include a permission type can include a P type, a NP type, and FP type, and can indicate an association relationship between the data item and the query type. For example, “NP: Request type=[0, 2]” in Table 1 indicates that a data item with a data type of NP matches request type 0 (i. e., NP Type) and request type 2 (i. e., FP) (as shown in the last column “association relationship” in Table 1). That is, when query requests of NP type and FP type are received, data items of NP type may be returned.

For another example, “P: request type=1” in Table 1 indicates that a data item with a data type of P matches the request type 1 (i. e. P type) (as shown by the last column “association relationship” in Table 1). That is, when a query request of a P type is received, a data item of the P type may be returned. For another example, “FP: request type=2” in Table 1 indicates that a data item with a data type of FP matches the request type 2(i. e. an FP type) (as shown by the last column “association relationship” in Table 1). That is, when a query request of an FP type is received, a data item of the FP type may be returned.

According to some example implementations of the present disclosure, the plurality of data items are provided by at least one data provider, and the data type of the data item is set based on configuration data of the provider of the data item. It should be appreciated that the respective data items may be provided to the data set by a plurality of data providers in the recommendation system. For example, a news provider may provide a plurality of news data items, an encyclopedia provider may provide a plurality of encyclopedia data items, etc.

In this case, each provider may set a corresponding data type for a data item provided by himself/herself: for example, NP, P or FP, etc. With example implementations of the present disclosure, more data items may be allowed to be recommended, thereby mitigating the problem of only obtaining minimal recommendation data without using the first type data. Specifically, the provider may set the data type of the data item provided by himself/herself as the NP type, and in this case, the data item may be selected as the recommendation data regardless of whether the first type data is allowed to be used during the recommendation process.

In accordance with some example implementations of the present disclosure, a query request for querying a data set may be generated based on the second feature data. A recommendation model may be utilized to determine data items that match the query request and to update a group of data items based on the data items. Further details are described with reference to FIG. 4, which illustrates a block diagram 400 of a data recommendation process in accordance with some implementations of the present disclosure. As shown in FIG. 4, the portions that are not allowed to be used may be removed from the first feature data 210 based on the permission type 230 to form the second feature data 220. The request type 410 may be determined in the manner described above.

Further, the query request 420 may be generated based on the second feature data, alternatively and/or additionally, the request type 410 may be added to the query request 420 as a separate data dimension. Then, the query request 420 may be input into the recommendation model 240 to obtain a corresponding recommendation result. A final recommendation result may be determined based on the recommendation result and a group of data items obtained in the manner of Table 1. In this way, feature data may be used as permitted by a user, and data recommendation performance may be improved while ensuring data security (e. g., without using first type data).

According to some example implementations of the present disclosure, the recommendation model is determined based on reference feature data of a reference object, the reference feature data including a plurality of feature dimensions. It should be understood that the recommendation model trained in the existing manner may be used continuously without changing the feature width of the recommendation model or retraining the recommendation model. In this way, the proposed data recommendation technical solution can be made compatible with the existing recommendation model, thereby reducing various resource overheads involved in data recommendation.

According to some example implementations of the present disclosure, in different recommendation systems, data items may have different formats, including, but not limited to, text, image, audio, video, short videos, etc.

According to some example implementations of the present disclosure, value factors of the recommended data items may be further considered in the data recommendation process so that the data recommendation process may achieve higher value goals.

According to some example implementations of the present disclosure, in response to determining that the permission type indicates that all of the first feature data is allowed to be used, a data recommendation process may be performed based on existing technical solutions.

In accordance with some example implementations of the present disclosure, in response to determining that there is a plurality of objects, a first group of objects specifying a first permission type and a second group of objects specifying a second permission type among the plurality of objects may be determined. Further, different recommendation policies may be developed for the first group of objects and the second group of objects, respectively. For example, given that the first group of objects allows the use of first type data and the second group of objects prohibits the use of first type data, data items capable of achieving higher value goals may be preferentially recommended to the first group of objects. Since allowing the use of the first type data can improve the accuracy of data recommendations, a higher interest of the first group of objects in the data items being recommended can thereby achieve a higher value goal. The data items may be recommended to the second group of users based on existing recommendation policies, alternatively and/or additionally, lesser consideration may be given to the value goals that can be achieved by the data items recommended to the second group of objects.

It should be appreciated that only the entire process of the data recommendation process is described above. Alternatively and/or additionally, various specific steps in the data recommendation process may be executed using the above-described technical solutions. For example, the technical solution described above may be used in one or more steps such as a data orientation step, a recall step, a coarse ranking step, a fine ranking step, and a prediction step. In particular, various steps may be performed using second feature data generated according to the process described above.

With exemplary implementations of the present disclosure, permission types can be utilized to indicate portions of feature data that is allowed to be used and/or portions of feature data that is not allowed to be used. In this way, the data security of the data recommendation process may be improved, and the data recommendation performance is improved on the basis of ensuring the data security.

### Example Processes

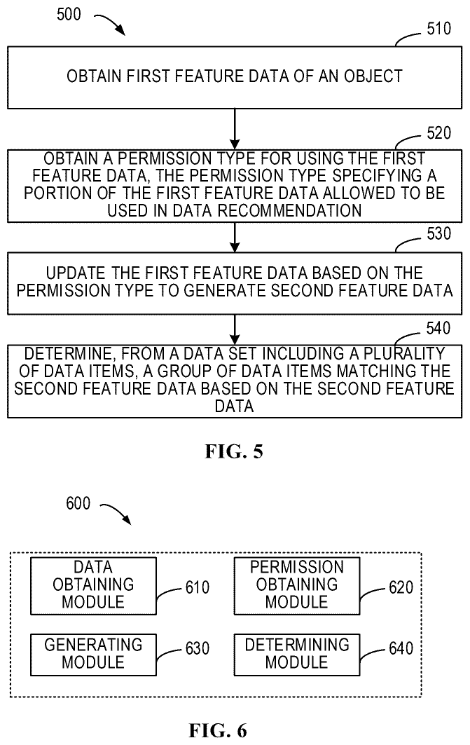

FIG. 5 illustrates a flowchart of a method 500 for recommending data, in accordance with some implementations of the present disclosure. At block 510, first feature data of an object is obtained. At block 520, a permission type for using the first feature data is obtained, the permission type specifying a portion of the first feature data allowed to be used in the data recommendation. At block 530, the first feature data is updated based on the permission type to generate second feature data. At block 540, based on the second feature data, a group of data items matching the second feature data is determined from a data set including a plurality of data items.

According to some example implementations of the present disclosure, the first feature data includes a plurality of feature dimensions of the object, the permission type indicates at least a portion of the plurality of feature dimensions, and generating the second feature data includes: generating the second feature data based on at least a portion of the feature dimensions.

According to some example implementations of the present disclosure, the at least a portion of the feature dimension includes first type data associated with the object, the first type data including first type data within the data set and first type data out of the data set; and second type data associated with the object.

According to some example implementations of the present disclosure, the method 500 further includes: determining region information corresponding to the object; and determining the at least a portion of feature dimension based on the region information.

According to some example implementations of the present disclosure, determining the group of data items includes: determining, based on the permission type, a request type of a query request for querying the data set; and obtaining, from the plurality of data items, the group of data items matching the request type.

According to some example implementations of the present disclosure, a data item of the plurality of data items has a data type, the data type indicating an association relationship between the data item and the query type, and obtaining the group of data items includes in response to determining that the association relationship indicates the data type of the data item matching the query type, adding the data item to the group of data items.

According to some example implementations of the present disclosure, the plurality of data items are provided by at least one data provider and the data type of the data items is set based on configuration data from the provider of the data items.

According to some example implementations of the present disclosure, the method 500 further includes: generating the query request for querying the data set based on the second feature data; determining, using a recommendation model, a data item matching the query request; and updating a set of data items based on the data item.

According to some example implementations of the present disclosure, the recommendation model is determined based on reference feature data of a reference object, the reference feature data including the plurality of feature dimensions.

According to some example implementations of the present disclosure, the number of first dimensions of the first feature data is the same as the number of second dimensions of the second feature data, and other feature dimensions than the at least a portion of feature dimensions in the second feature data are set to null.

### Example Apparatus and Device

FIG. 6 illustrates a block diagram of an apparatus 600 for recommending data, in accordance with some implementations of the present disclosure. The apparatus 600 includes: a data obtaining module 610 configured to obtain first feature data of an object; a permission obtaining module 620 configured to obtain a permission type for using the first feature data, the permission type specifying a portion of the first feature data allowed to be used in data recommendation; a generating module 630 configured to update the first feature data based on the permission type to generate second feature data; and a determining module 640 configured to determine, from a data set including a plurality of data items, a group of data items matching the second feature data based on the second feature data.

According to some example implementations of the present disclosure, the first feature data includes a plurality of feature dimensions of the object, the permission type indicating at least a portion of the plurality of feature dimensions, and the generating module includes: generating the second feature data based on the at least a portion of the feature dimensions.

According to some example implementations of the present disclosure, the at least a portion of the feature dimension includes at least one of: first type data associated with the object, the first type data including first type data within the data set and first type data out of the data set; and second type data associated with the object.

According to some example implementations of the present disclosure, the apparatus further includes: determining region information corresponding to the object; and determining the at least a portion of feature dimension based on the region information.

According to some example implementations of the present disclosure, the determining module includes: a request type determining module configured to determine, based on the permission type, a request type of a query request for querying the data set; and a data item obtaining module configured to obtain, from the plurality of data items, the group of data items matching the request type.

According to some example implementations of the present disclosure, a data item of the plurality of data items has a data type, the data type indicating an association relationship between the data item and the query type, and the data item obtaining module includes: an adding module configured to add, in response to determining that the association relationship indicates the data type of the data item matching the query type, the data item to the group of data items.

According to some example implementations of the present disclosure, the plurality of data items are provided by at least one data provider and the data type of the data items is set based on configuration data by the provider of the data items.

According to some example implementations of the present disclosure, the apparatus further includes: a request generating module configured to generate the query request for querying the data set based on the second feature data; a recommending module configured to determine, using a recommendation model, a data item matching the query request; and an updating module configured to update the group of data items based on the data item.

According to some example implementations of the present disclosure, the recommendation model is determined based on reference feature data of a reference object, the reference feature data including the plurality of feature dimensions.

According to some example implementations of the present disclosure, the number of first dimensions of the first feature data is the same as the number of second dimensions of the second feature data, and other feature dimensions than the at least a portion of feature dimensions in the second feature data are set to null.

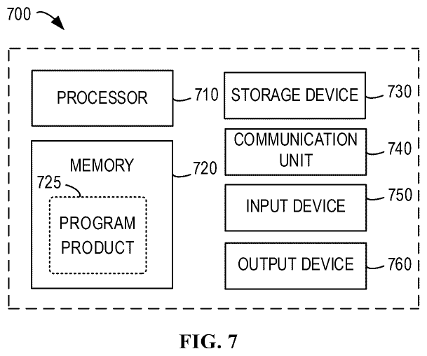

FIG. 7 illustrates a block diagram of an apparatus 700 capable of implementing various implementations of the present disclosure. It should be understood that the computing device 700 shown in FIG. 7 is merely exemplary and should not constitute any limitation on the functionality and scope of the implementations described herein. The computing device 700 shown in FIG. 7 may be used to implement the methods described above.

As shown in FIG. 7, the computing device 700 is in the form of a general-purpose computing device. Components of the computing device 700 may include, but are not limited to, at least one processor 710 or processing unit, a memory 720, a storage device 730, one or more communications units 740, one or more input devices 750, and one or more output devices 760. The processor 710 may be an actual or virtual processor and can perform various processes according to programs stored in the memory 720. In a multiprocessor system, a plurality of processors executes computer executable instructions in parallel, so as to improve the parallel processing capability of the computing device 700.

The computing device 700 typically includes a number of computer storage media. Such media may be any available media that are accessible by the computing device 700, including, but not limited to, volatile and non-volatile media, removable and non-removable media. The memory 720 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data (such as training data for training) and that can be accessed within the computing device 700.

The computing device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various implementations of the present disclosure.

The communication unit 740 implements communication with other computing devices through a communication medium. In addition, functions of components of the computing device 700 may be implemented by a single computing cluster or a plurality of computing machines, and these computing machines can communicate through a communication connection. Thus, the computing device 700 may operate in a networked environment using logical connections to one or more other servers, network personal computers (PCs), or another network node.

The input device 750 may be one or more input devices such as a mouse, keyboard, trackball, etc. The output device 760 may be one or more output devices such as a display, speaker, printer, etc. The computing device 700 may also communicate with one or more external devices (not shown) such as a storage device, a display device, or the like through the communication unit 740 as required, and communicate with one or more devices that enable a user to interact with the computing device 700, or communicate with any device (e. g., a network card, a modem, or the like) that enables the computing device 700 to communicate with one or more other electronic devices. Such communication may be performed via an input/output (I/O) interface (not shown).

According to an exemplary implementation of the present disclosure, a computer readable storage medium is provided, on which a computer-executable instruction is stored, where the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above. According to exemplary implementation of the present disclosure, there is provided a computer program product, on which a computer program is stored, and the program implements the above-described method when being executed.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for recommending data, comprising:
obtaining first feature data of an object;
obtaining a permission type for using the first feature data, the permission type specifying a portion of the first feature data allowed to be used in data recommendation;
updating the first feature data based on the permission type to generate second feature data; and
determining, from a data set comprising a plurality of data items, a group of data items matching the second feature data based on the second feature data.

2. The method of claim 1, wherein the first feature data comprises a plurality of feature dimensions of the object, the permission type indicates at least a portion of the plurality of feature dimensions, and generating the second feature data comprises:
generating the second feature data based on the at least a portion of the feature dimensions.

3. The method of claim 2, wherein the at least a portion of the feature dimension comprises at least one of:
first type data associated with the object, the first type data comprising first type data within the data set and first type data beyond the data set; and
second type data associated with the object.

4. The method of claim 2, further comprising:
determining region information corresponding to the object; and
determining the at least a portion of feature dimension based on the region information.

5. The method of claim 1, wherein determining the group of data items comprises:
determining, based on the permission type, a request type of a query request for querying the data set; and
obtaining, from the plurality of data items, the group of data items matching the request type.

6. The method of claim 5, wherein a data item of the plurality of data items has a data type indicating an association relationship between the data item and the query type, and obtaining the group of data items comprises:
in response to determining that the association relationship indicates the data type of the data item matching the query type, adding the data item to the group of data items.

7. The method of claim 6, wherein the plurality of data items is provided by at least one data provider and the data type of the data items is set based on configuration data from the provider of the data items.

8. The method of claim 5, further comprising:
generating the query request for querying the data set based on the second feature data;
determining, using a recommendation model, a data item matching the query request; and
updating the group of data items based on the data item.

9. The method of claim 8, wherein the recommendation model is determined based on reference feature data of a reference object, the reference feature data comprising the plurality of feature dimensions.

10. The method of claim 2, wherein a first number of dimensions of the first feature data is the same as a second number of dimensions of the second feature data, and other feature dimensions than the at least a portion of feature dimensions in the second feature data are set to null.

11. An electronic device, comprising:
at least one processor;
at least one memory coupled to the at least one processor and storing instructions for execution by the at least one processor that, when being executed by the at least one processor, cause the electronic device to perform acts for recommending data, the acts comprising:
obtaining first feature data of an object;
obtaining a permission type for using the first feature data, the permission type specifying a portion of the first feature data allowed to be used in data recommendation;
updating the first feature data based on the permission type to generate second feature data; and
determining, from a data set comprising a plurality of data items, a group of data items matching the second feature data based on the second feature data.

12. The device of claim 11, wherein the first feature data comprises a plurality of feature dimensions of the object, the permission type indicates at least a portion of the plurality of feature dimensions, and generating the second feature data comprises:
generating the second feature data based on the at least a portion of the feature dimensions.

13. The method of claim 12, wherein the at least a portion of the feature dimension comprises at least one of:
first type data associated with the object, the first type data comprising first type data within the data set and first type data beyond the data set; and
second type data associated with the object.

14. The method of claim 12, wherein the acts further comprise:
determining region information corresponding to the object; and
determining the at least a portion of feature dimension based on the region information.

15. The method of claim 11, wherein determining the group of data items comprises:
determining, based on the permission type, a request type of a query request for querying the data set; and
obtaining, from the plurality of data items, the group of data items matching the request type.

16. The method of claim 15, wherein a data item of the plurality of data items has a data type indicating an association relationship between the data item and the query type, and obtaining the group of data items comprises:
in response to determining that the association relationship indicates the data type of the data item matching the query type, adding the data item to the group of data items.

17. The method of claim 16, wherein the plurality of data items is provided by at least one data provider and the data type of the data items is set based on configuration data from the provider of the data items.

18. The method of claim 15, wherein the acts further comprise:
generating the query request for querying the data set based on the second feature data;
determining, using a recommendation model, a data item matching the query request; and
updating the group of data items based on the data item.

19. The method of claim 18, wherein the recommendation model is determined based on reference feature data of a reference object, the reference feature data comprising the plurality of feature dimensions.

20. A non-transitory computer readable storage medium having a computer program stored thereon, the computer program, when being executed by a processor, causing the processor to implement acts for recommending data, the acts comprising:
obtaining first feature data of an object;
obtaining a permission type for using the first feature data, the permission type specifying a portion of the first feature data allowed to be used in data recommendation;
updating the first feature data based on the permission type to generate second feature data; and
determining, from a data set comprising a plurality of data items, a group of data items matching the second feature data based on the second feature data.
